(19) United States
(12) Patent Application Publication
(10) Pub. No.: US 2010/0281435 A1
(43) Pub. Date: Nov. 4, 2010

(54) SYSTEM AND METHOD FOR MULTIMODAL INTERACTION USING ROBUST GESTURE PROCESSING

(75) Inventors: Srinivas Bangalore, Morristown, NJ (US); Michael Johnston, New York, NY (US)

Correspondence Address: AT & T LEGAL DEPARTMENT - NDQ, ATTN: PATENT DOCKETING, ONE AT & T WAY, ROOM 2A-207, BEDMINSTER, NJ, 07921, US

(73) Assignee: AT&T Intellectual Property I, L.P., Reno, NV (US)

(21) Appl. No.: 12/433,320

(22) Filed: Apr. 30, 2009

(51) Int. Cl. G06F 3/033

(52) U.S. Cl. 715/863; 345/173

(57) ABSTRACT

Disclosed herein are systems, computer-implemented methods, and tangible computer-readable media for multimodal interaction. The method includes receiving a plurality of multimodal inputs associated with a query, the plurality of multimodal inputs including at least one gesture input, editing the at least one gesture input with a gesture edit machine. The method further includes responding to the query based on the edited gesture input and remaining multimodal inputs. The gesture inputs can be from a stylus, finger, mouse, and other pointing/gesture device. The gesture input can be unexpected or errorful. The gesture edit machine can perform actions such as deletion, substitution, insertion, and aggregation. The gesture edit machine can be modeled as a finite-state transducer. In one aspect, the method further includes generating a lattice for each input, generating an integrated lattice of combined meaning of the generated lattices, and responding to the query further based on the integrated lattice.

### BACKGROUND OF THE INVENTION

1. Field of the Invention

The present invention relates to user interactions and more specifically to robust processing of multimodal user interactions.

2. Introduction

The explosive growth of mobile communication networks and advances in the capabilities of mobile computing devices now make it possible to access almost any information from virtually everywhere. However, the inherent characteristics and traditional user interfaces of mobile devices still severely constrain the efficiency and utility of mobile information access. For example, mobile device interfaces are designed around small screen size and the lack of a viable keyboard or mouse. With small keyboards and limited display area, users find it difficult, tedious, and/or cumbersome to maintain established techniques and practices used in non-mobile human-computer interaction.

Further, approaches known in the art typically encounter great difficulty when confronted with unanticipated or erroneous input. Previous approaches in the art have focused on serial speech interactions and the peculiarities of speech input and how to modify speech input for best recognition results. These approaches are not always applicable to other forms of input.

Accordingly, what is needed in the art is an improved way to interact with mobile devices in a more efficient, natural, and intuitive manner that appropriately accounts for unexpected input in modes other than speech.

### SUMMARY

Additional features and advantages of the invention will be set forth in the description which follows, and in part will be obvious from the description, or may be learned by practice of the invention. The features and advantages of the invention may be realized and obtained by means of the instruments and combinations particularly pointed out in the appended claims. These and other features of the present invention will become more fully apparent from the following description and appended claims, or may be learned by the practice of the invention as set forth herein.

Disclosed herein are systems, computer-implemented methods, and tangible computer-readable media for multimodal interaction. The method includes receiving a plurality of multimodal inputs associated with a query, the plurality of multimodal inputs including at least one gesture input. The method then includes editing the at least one gesture input with a gesture edit machine and responding to the query based on the edited at least one gesture input and remaining multimodal inputs. The remaining multimodal inputs can be either edited or unedited. The gesture inputs can be from a stylus, finger, mouse, infrared-sensor equipped pointing device, gyroscope-based device, accelerometer-based device, compass-based device, motion in the air such as hand motions that are received as gesture input, and other pointing/gesture devices. The gesture input can be unexpected or errorful. The gesture edit machine can perform actions such as deletion, substitution, insertion, and aggregation. The gesture edit machine can be modeled as a finite-state transducer. In one aspect, the method further generates a lattice for each input, generates an integrated lattice of combined meaning of the generated lattices, and responds to the query further based on the integrated lattice.

### BRIEF DESCRIPTION OF THE DRAWINGS

In order to describe the manner in which the above-recited and other advantages and features of the invention can be obtained, a more particular description of the invention briefly described above will be rendered by reference to specific embodiments thereof which are illustrated in the appended drawings. Understanding that these drawings depict only exemplary embodiments of the invention and are not therefore to be considered to be limiting of its scope, the invention will be described and explained with additional specificity and detail through the use of the accompanying drawings in which:

FIG. 1 illustrates an example system embodiment;

FIG. 2 illustrates an example method embodiment;

FIG. 3A illustrates unimodal pen-based input;

FIG. 3B illustrates two-area pen-based input as part of a multimodal input;

FIG. 3C illustrates a system response to multimodal input;

FIG. 3D illustrates unimodal pen-based input as an alternative to FIG. 3B;

FIG. 4 illustrates an example arrangement of a multimodal understanding component;

FIG. 5 illustrates example lattices for speech, gesture, and meaning;

FIG. 6 illustrates an example multimodal three-tape finite-state automaton;

FIG. 7 illustrates an example gesture/speech alignment transducer;

FIG. 8 illustrates an example gesture/speech to meaning transducer;

FIG. 9 illustrates an example basic edit machine;

FIG. 10 illustrates an example finite-state transducer for editing gestures;

FIG. 11A illustrates a sample single pen-based input selecting three items;

FIG. 11B illustrates a sample triple pen-based input selecting three items;

FIG. 11C illustrates a sample double pen-based errorful input selecting three items;

FIG. 11D illustrates a sample single line pen-based input selecting three items;

FIG. 11E illustrates a sample two line pen-based input selecting three items and errorful input;

FIG. 11F illustrates a sample tap and line pen-based input selecting three items;

FIG. 11G illustrates a sample multiple line pen-based input selecting three items;

FIG. 12A illustrates an example gesture lattice after aggregation; and

FIG. 12B illustrates an example gesture lattice before aggregation.

### DETAILED DESCRIPTION

Various embodiments of the invention are discussed in detail below. While specific implementations are discussed, it should be understood that this is done for illustration purposes only. A person skilled in the relevant art will recognize that other components and configurations may be used without parting from the spirit and scope of the invention.

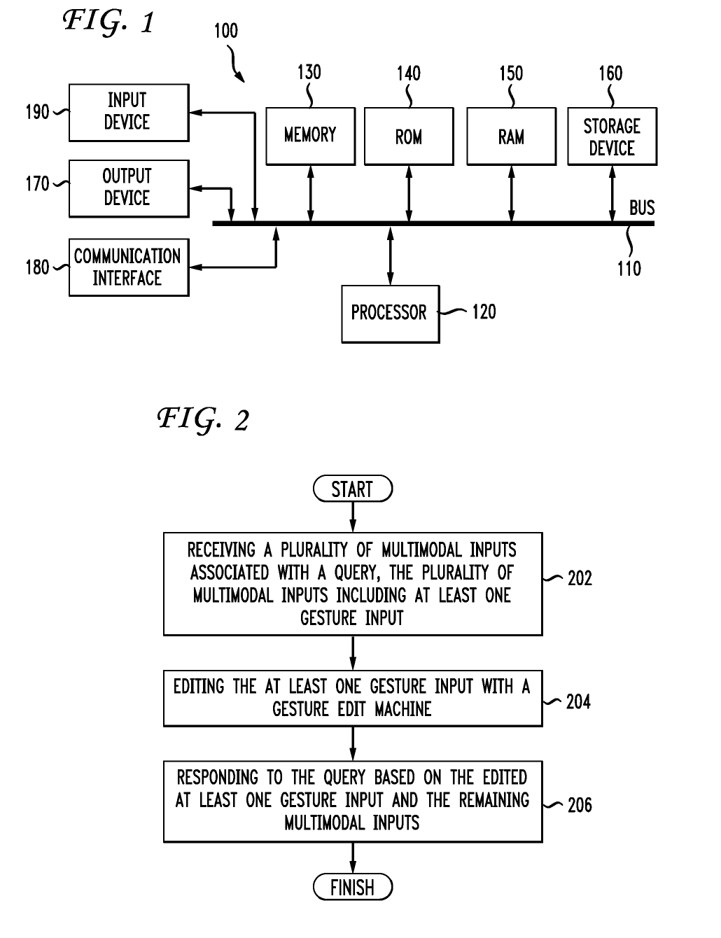

With reference to FIG. 1, an exemplary system includes a general-purpose computing device 100, including a processing unit (CPU) 120 and a system bus 110 that couples various system components including the system memory such as read only memory (ROM) 140 and random access memory (RAM) 150 to the processing unit 120. Other system memory 130 may be available for use as well. It can be appreciated that the invention may operate on a computing device with more than one CPU 120 or on a group or cluster of computing devices networked together to provide greater processing capability. A processing unit 120 can include a general purpose CPU controlled by software as well as a special-purpose processor. An Intel Xeon LV L7345 processor is an example of a general purpose CPU which is controlled by software. Particular functionality may also be built into the design of a separate computer chip. An STMicroelectronics STA013 processor is an example of a special-purpose processor which decodes MP3 audio files. Of course, a processing unit includes any general purpose CPU and a module configured to control the CPU as well as a special-purpose processor where software is effectively incorporated into the actual processor design. A processing unit may essentially be a completely self-contained computing system, containing multiple cores or CPUs, a bus, memory controller, cache, etc. A multi-core processing unit may be symmetric or asymmetric.

The system bus 110 may be any of several types of bus structures including a memory bus or memory controller, a peripheral bus, and a local bus using any of a variety of bus architectures. A basic input/output (BIOS) stored in ROM 140 or the like, may provide the basic routine that helps to transfer information between elements within the computing device 100, such as during start-up. The computing device 100 further includes storage devices such as a hard disk drive 160, a magnetic disk drive, an optical disk drive, tape drive or the like. The storage device 160 is connected to the system bus 110 by a drive interface. The drives and the associated computer readable storage media provide nonvolatile storage of computer readable instructions, data structures, program modules and other data for the computing device 100. In one aspect, a hardware module that performs a particular function includes the software component stored in a tangible and/or intangible computer-readable medium in connection with the necessary hardware components, such as the CPU, bus, display, and so forth, to carry out the function. The basic components are known to those of skill in the art and appropriate variations are contemplated depending on the type of device, such as whether the device is a small, handheld computing device, a desktop computer, or a computer server.

Although the exemplary environment described herein employs the hard disk, it should be appreciated by those skilled in the art that other types of computer readable media which can store data that are accessible by a computer, such as magnetic cassettes, flash memory cards, digital versatile disks, cartridges, random access memories (RAMs), read only memory (ROM), a cable or wireless signal containing a bit stream and the like, may also be used in the exemplary operating environment.

To enable user interaction with the computing device 100, an input device 190 represents any number of input mechanisms, such as a microphone for speech, a touch-sensitive screen for gesture or graphical input, keyboard, mouse, motion input, speech and so forth. The input may be used by the presenter to indicate the beginning of a speech search query. The device output 170 can also be one or more of a number of output mechanisms known to those of skill in the art. In some instances, multimodal systems enable a user to provide multiple types of input to communicate with the computing device 100. The communications interface 180 generally governs and manages the user input and system output. There is no restriction on the invention operating on any particular hardware arrangement and therefore the basic features here may easily be substituted for improved hardware or firmware arrangements as they are developed.

For clarity of explanation, the illustrative system embodiment is presented as comprising individual functional blocks (including functional blocks labeled as a “processor”). The functions these blocks represent may be provided through the use of either shared or dedicated hardware, including, but not limited to, hardware capable of executing software and hardware, such as a processor, that is purpose-built to operate as an equivalent to software executing on a general purpose processor. For example the functions of one or more processors presented in FIG. 1 may be provided by a single shared processor or multiple processors. (Use of the term “processor” should not be construed to refer exclusively to hardware capable of executing software.) Illustrative embodiments may comprise microprocessor and/or digital signal processor (DSP) hardware, read-only memory (ROM) for storing software performing the operations discussed below, and random access memory (RAM) for storing results. Very large scale integration (VLSI) hardware embodiments, as well as custom VLSI circuitry in combination with a general purpose DSP circuit, may also be provided.

The logical operations of the various embodiments are implemented as: (1) a sequence of computer implemented steps, operations, or procedures running on a programmable circuit within a general use computer, (2) a sequence of computer implemented steps, operations, or procedures running on a specific-use programmable circuit; and/or (3) interconnected machine modules or program engines within the programmable circuits.

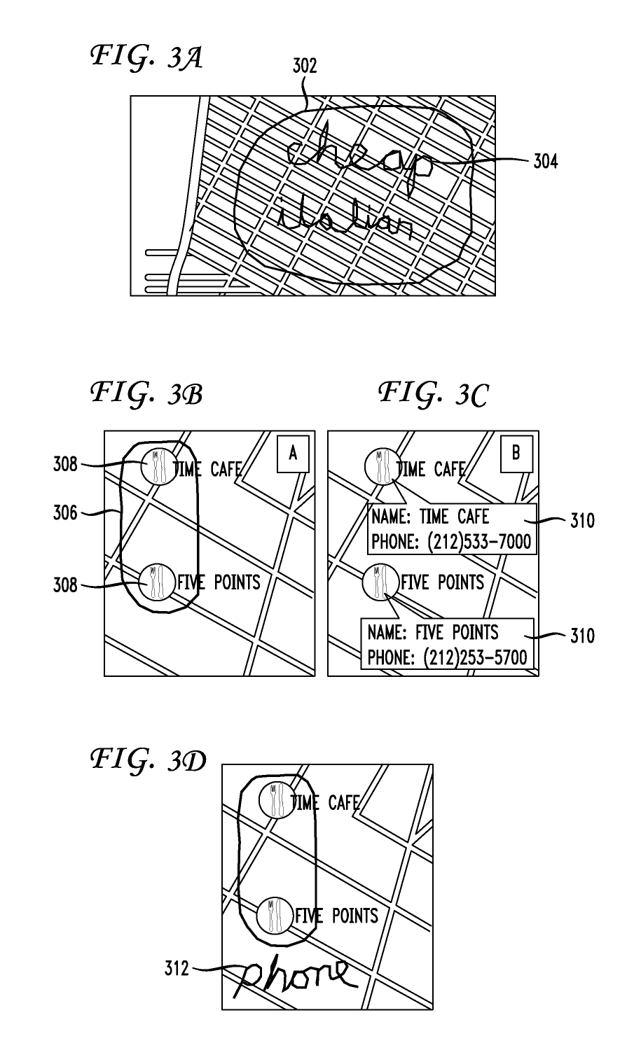

Having disclosed some basic system components, the disclosure now turns to the exemplary method embodiment. The method is discussed in terms of a local search application by way of example. The method embodiment can be implemented by a computer hardware device. The technique and principles of the invention can be applied to any domain and application. For clarity, the method and various embodiments are discussed in terms of a system configured to practice the method. FIG. 2 illustrates an exemplary method embodiment for multimodal interaction. The system first receives a plurality of multimodal inputs associated with a query, the plurality of multimodal inputs including at least one gesture input (202). The gesture inputs can contain one or more unexpected or errorful gesture. For example, if a user gestures in haste and the gesture is incomplete or inaccurate, the user can add a gesture to correct it. The initial gesture may also have errors that are uncorrected. The system can receive multiple multimodal inputs as part of a single turn of interaction. Gesture inputs can include stylus-based input, finger-based touch input, mouse input, and other pointing device input. Other pointing devices can include infrared-sensor equipped pointing devices, gyroscope-based devices, accelerometer-based devices, compass-based devices, and so forth. The system may also receive motion in the air such as hand motions that are received as gesture input.

The system edits the at least one gesture input with a gesture edit machine (204). The gesture edit machine can perform actions such as deletion, substitution, insertion, and aggregation. In one example of deletion, the gesture edit machine removes unintended gestures from processing. In an example of aggregation, a user draws two half circles representing a whole circle. The gesture edit machine can aggregate the two half circle gestures into a single circle gesture, thereby creating a single conceptual input. The system can handle this as part of gesture recognition. The gesture recognizer can consider both individual strokes and combinations of strokes is classifying gestures before aggregation. In one variation, a finite-state transducer models the gesture edit machine.

The system responds to the query based on the edited at least one gesture input and the remaining multimodal inputs (206). The system can respond to the query by outputting a multimodal presentation that synchronizes one or more of graphical callouts, still images, animation, sound effects, and synthetic speech. For example, the system can output speech instructions while showing an animation of a dotted red line on a map leading to an icon representing a destination.

In one embodiment, the system further generates a lattice for each multimodal input, generates an integrated lattice which represents a combined meaning of the generated lattices by combining the generated lattices, and responds to the query further based on the integrated lattice. In this embodiment, the system can also capture the alignment of the lattices in a single declarative multimodal grammar representation. A cascade of finite state operations can align and integrate content in the lattices. The system can also compile the multimodal grammar representation into a finite-state machine operating over each of the plurality of multimodal inputs and over the combined meaning.

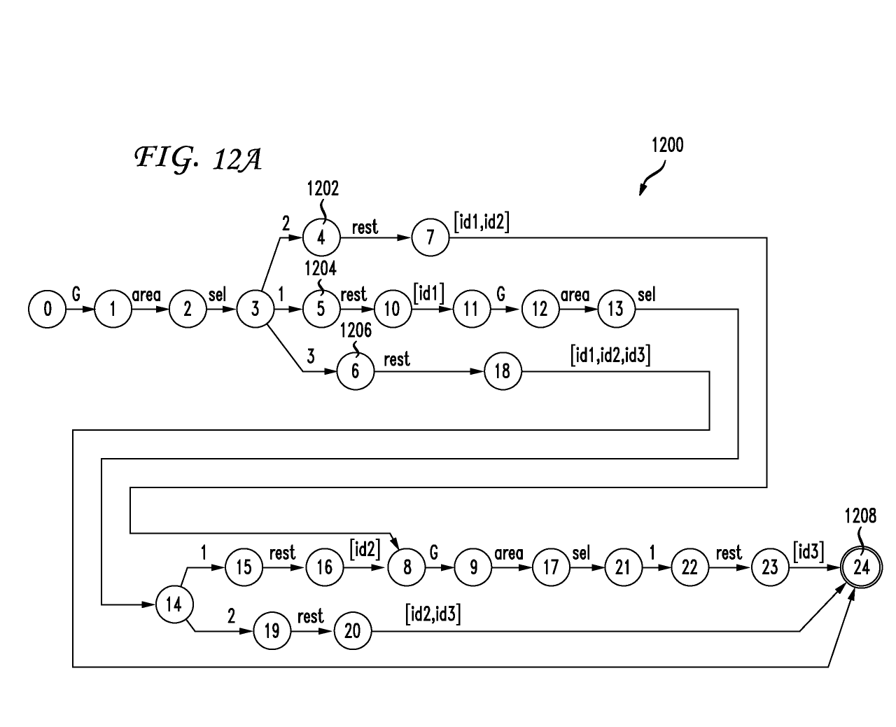

One aspect of the invention concerns the use of multimodal language processing techniques to enable interfaces combining speech and gesture input that overcome traditional human-computer interface limitations. One specific focus is robust processing of pen gesture inputs in a local search application. Gestures can also include stylus-based input, finger-based touch input, mouse input, other pointing device input, locational input (such as input from a gyroscope, accelerometer, or Global Positioning System (GPS)), and even hand waving or other physical gestures in front of a camera or sensor. Although much of the disclosure discusses pen gestures, the principles disclosed herein are equally applicable to other kinds of gestures. Gestures can also include unexpected and/or errorful gestures, such as those shown in the variations shown in FIGS. 11A-G. Edit-based techniques that have proven effective in spoken language processing can also be used to overcome unexpected or errorful gesture input, albeit with some significant modifications outlined herein. A bottom-up gesture aggregation technique can improve the coverage of multimodal understanding.

In one aspect, multimodal interaction on mobile devices includes speech, pen, and touch input. Pen and touch input include different types of gestures, such as circles, arrows, points, writing, and others. Multimodal interfaces can be extremely effective when they allow users to combine multiple modalities in a single turn of interaction, such as allowing a user to issue a command using both speech and pen modalities simultaneously. Specific non-limiting examples of a user issuing simultaneous multimodal commands are given below. This kind of multimodal interaction requires integration and understanding of information distributed in two or more modalities and information gleaned from the timing and interrelationships of two or more modalities. This disclosure discusses techniques to provide robustness to gesture recognition errors and highlights an extension of these techniques to gesture aggregation, where multiple pen gestures are interpreted as a single conceptual gesture for the purposes of multimodal integration and understanding.

In the modern world, whether travelling or going about their daily business, users need to access a complex and constantly changing body of information regarding restaurants, shopping, cinema and theater schedules, transportation options and timetables, and so forth. This information is most valuable if it is current and can be delivered while mobile, since users often change plans while mobile and the information itself is highly dynamic (e.g. train and flight timetables change, shows get cancelled, and restaurants get booked up).

Many of the examples and much of the data used to illustrate the principles of the invention incorporate information from MATCH (Multimodal Access To City Help), a city guide and navigation system that enables mobile users to access restaurant and subway information for urban centers such as New York City and Washington, D.C. However, the techniques described apply to a broad range of mobile information access and management applications beyond MATCH's particular task domain, such as apartment finding, setting up and interacting with map-based distributed simulations, searching for hotels, location-based social interaction, and so forth. The principles described herein also apply to non-map task domains. MATCH represents a generic multimodal system for responding to user queries.

In the multimodal system, users interact with a graphical interface displaying restaurant listings and a dynamically updated map showing locations and street information. The multimodal system accepts user input such as speech, drawings on the display with a stylus, or synchronous multimodal combinations of the two modes. The user can ask for the review, cuisine, phone number, address, or other information about restaurants and for subway directions to locations. The multimodal system responds by generating multimodal presentations synchronizing one or more of graphical callouts, still images, animation, sound effects, and synthetic speech.

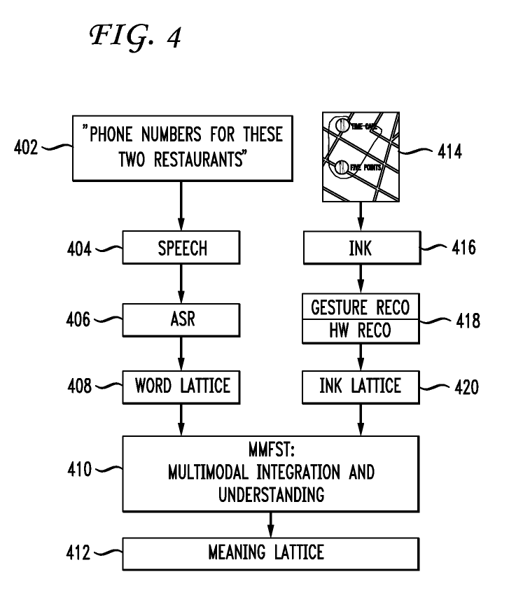

For example, a user can request to see restaurants using the spoken command “Show cheap Italian restaurants in Chelsea”. The system then zooms to the appropriate map location and shows the locations of suitable restaurants on the map. Alternatively, the user issues the same command multimodally by circling an area on the map and saying “show cheap Italian restaurants in this neighborhood”. If the immediate environment is too noisy or if the user is unable to speak, the user can issue the same command completely using a pen or a stylus as shown in FIG. 3A, by circling an area 302 and writing cheap and Italian 304.

Similarly, if the user says “phone numbers for theses two restaurants” and circles 306 two restaurants 308 as shown in FIG. 3B, the system draws a callout 310 with the restaurant name and number and synthesizes speech such as “Time Cafe can be reached at 212-533-7000”, for each restaurant in turn, as shown in FIG. 3C. If the immediate environment is too noisy, too public, or if the user does not wish to or cannot speak, the user can issue the same command completely in pen by circling 306 the restaurants and writing “phone” 312, as shown in FIG. 3D.

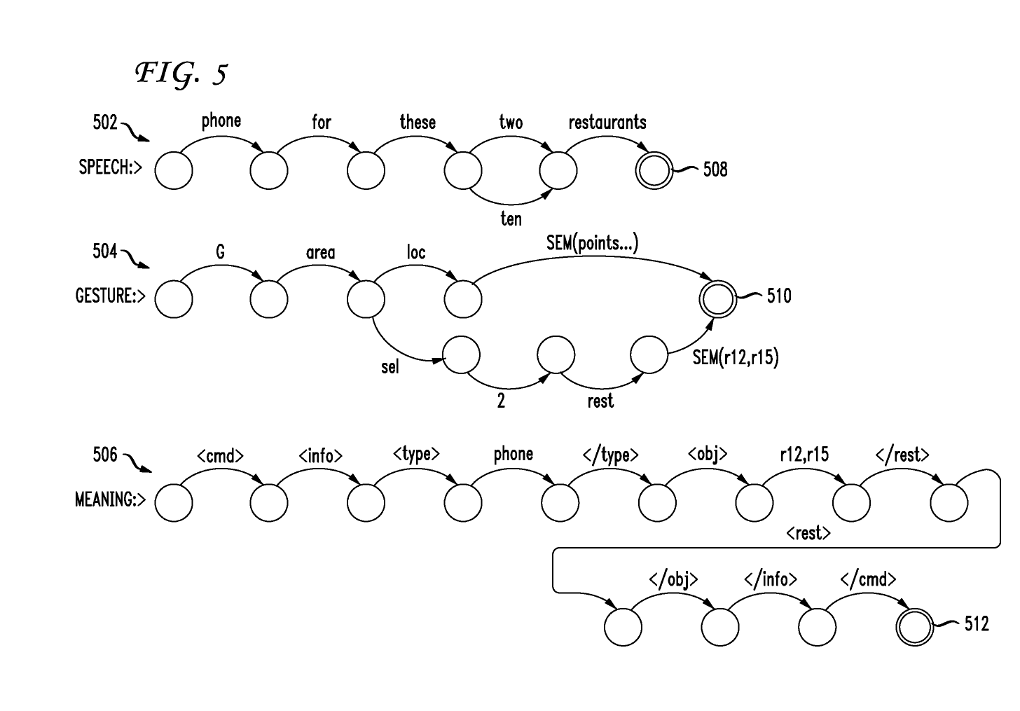

FIG. 4 illustrates an example arrangement of a multimodal understanding component. In this exemplary embodiment, a multimodal integration and understanding component (MMFST) 410 performs multimodal integration and understanding. MMFST 410 takes as input a word lattice 408 from speech recognition 404, 406 (such as “phone numbers for these two restaurants” 402) and/or a gesture lattice 420 which is a combination of results from handwriting recognition and gesture recognition 418 (such as pen/stylus drawings 414, 416, also referenced in FIGS. 3A-3D and in FIGS. 11A-11G). This section can also correct errorful gestures, such as the drawing 414 where the line does not completely enclose Time Café, but only intersects a portion of the desired object. MMFST 410 can use a cascade of finite state operations to align and integrate the content in the word and gesture lattices and output a meaning lattice 412 representative of the combined meanings of the word lattice 408 and the ink lattice 420. MMFST 410 can pass the meaning lattice 412 to a multimodal dialog manager for further processing.

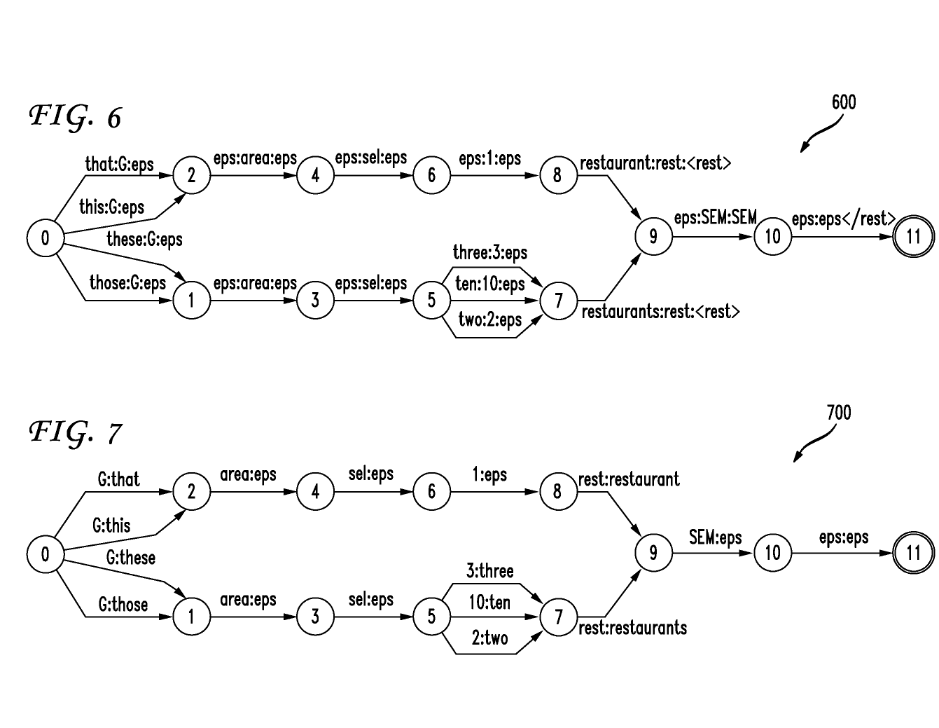

In the example of FIG. 3B above where the user says “phone for these two restaurants” while circling two restaurants, the speech recognizer 406 returns the word lattice labeled “Speech” 502 in FIG. 5. The gesture recognition component 418 returns a lattice labeled “Gesture” 504 in FIG. 5 indicating that the user's ink or pen-based gesture 306 of FIG. 3B is either a selection of two restaurants or a geographical area. MMFST 410 combines these two input lattices 408, 420 into a meaning lattice 412, 506 representing their combined meaning. MMFST 410 can pass the meaning lattice 410, 506 to a multimodal dialog manager and from there back to the user interface for display to the user, a partial example of which is shown in FIG. 3C. Display to the user can also involve coordinated text-to-speech output.

A single declarative multi-modal grammar representation captures the alignment of speech, gesture, and relation to their combined meaning. The non-terminals of the multimodal grammar are atomic symbols but each terminal 508, 510, 512 contains three components W:G:M corresponding to the n input streams and one output stream, where W represents the spoken language input stream, G represents the gesture input stream, and M represents the combined meaning output stream. The epsilon symbol ε indicates when one of these is empty within a given terminal. In addition to the gesture symbols (G area loc . . . ), G contains a symbol SEM used as a placeholder for specific content. Any symbol will do. SEM is used as a placeholder or variable for semantic data. For more information regarding the symbol SEM and for other related information, see U.S. patent application Ser. No. 10/216,392, publication number 2003-0065505-A1, which is incorporated herein by reference. The following Table 1 contains a small fragment of a multimodal grammar for use with a multimodal system, such as MATCH, which includes coverage for commands such as those in FIG. 5.

TABLE 1

| | | |
|---|---|---|
| S | → | ε:ε:<cmd> CMD ε:ε:</cmd> |
| CMD | → | ε:ε:<show> SHOW ε:ε:</show> |
| SHOW | → | ε:ε:<info> INFO ε:ε:</info> |
| INFO | → | show:ε:ε ε:ε:<rest> ε:ε:<cuis> CUISINE ε:ε:</cuis> |
| | | restaurants:ε:ε (ε:ε:<loc> LOCPP ε:ε:</loc> ) |
| CUISINE | → | Italian:ε:Italian \| Chinese:ε:Chinese \| newε:ε: |
| | | American:ε:American . . . |
| LOCPP | → | in:ε:ε LOCNP |
| LOCPP | → | here:G:ε ε:area:ε ε:loc:ε ε:SEM:SEM |
| LOCNP | → | ε:ε:<zone> ZONE ε:ε:</zone> |
| ZONE | → | Chelsea:ε:Chelsea \| Soho:ε:Soho \| Tribeca:ε:Tribeca . . . |
| TYPE | → | phone:ε:ε numbers:ε:phone \| review:ε:review \| |
| | | address:ε:address |
| DEICNP | → | DDETSG ε:area:ε ε:sel:ε ε:1:ε HEADSG |
| DEICNP | → | DDETPL ε:area:ε ε:sel:ε NUMPL HEADPL |
| DDETPL | → | these:G:ε \| those:G:ε |
| DDETSG | → | this:G:ε \| that:G:ε |
| HEADSG | → | restaurant:rest:<rest> ε:SEM:SEM ε:ε: </rest> |
| HEADPL | → | restaurant:rest:<rest> ε:SEM:SEM ε:ε: </rest> |
| NUMPL | → | two:2:ε \| three:3:ε . . . ten:10:ε |

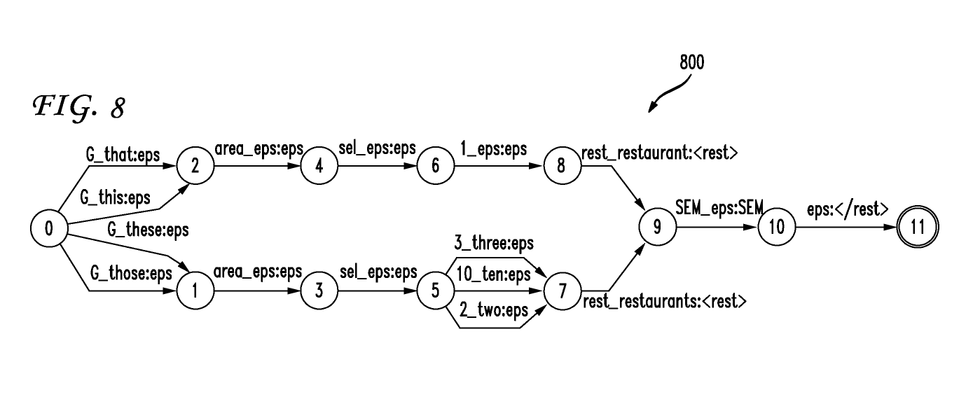

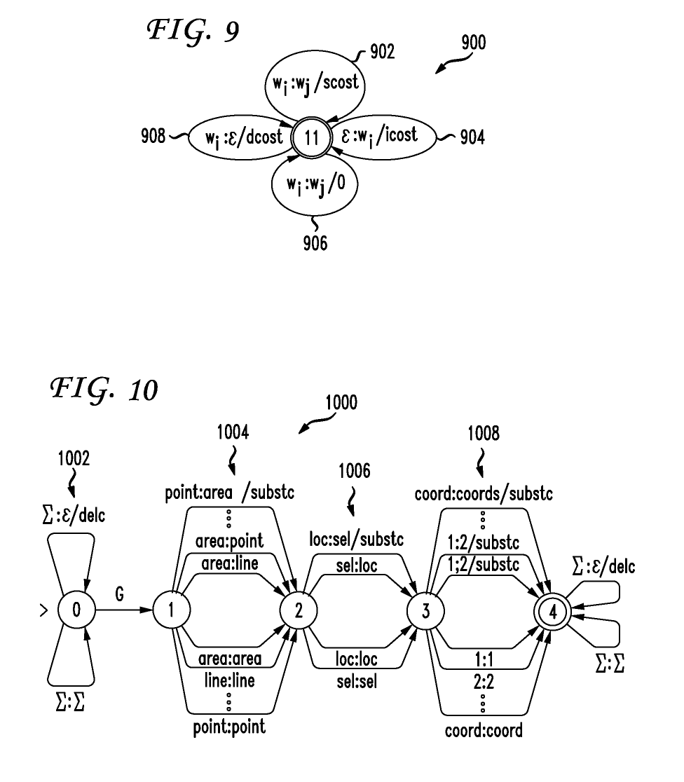

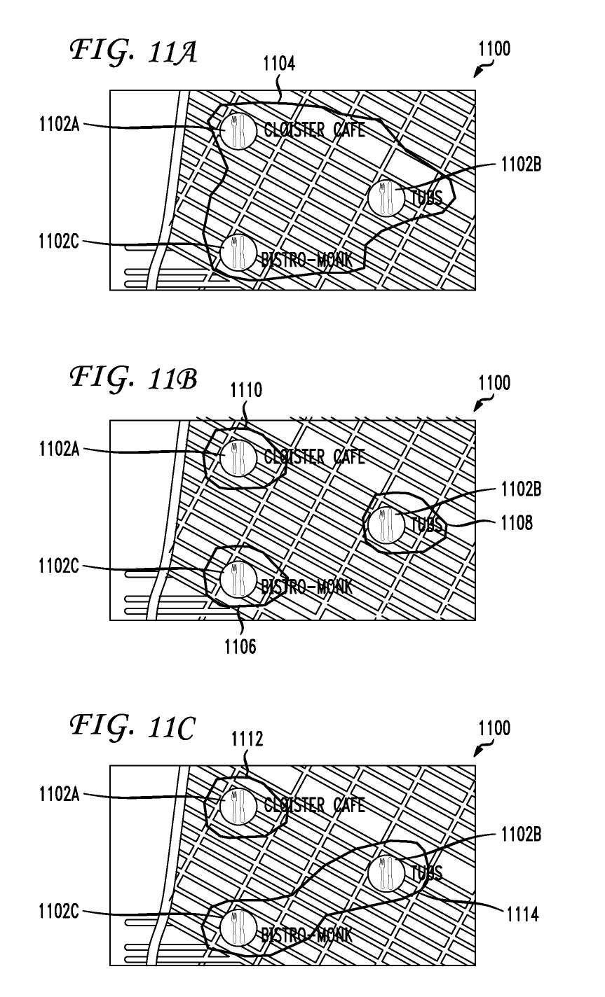

The system can compile the multimodal grammar into a finite-state device operating over two (or more) input streams, such as speech 502 and gesture 504, and one output stream, meaning 506. The transition symbols of the finite-state device correspond to the terminals of the multimodal grammar. For the sake of illustration here and in the following examples only a portion is shown of the three tape finite-state device which corresponds to the DEICNP rule in the grammar in Table 1. The corresponding finite-state device 600 is shown in FIG. 6. The system then factors the three tape machine into two transducers: R:G W and T:(G×W) M. In FIG. 7, R:G→W aligns the speech and gesture streams 700 through a composition with the speech and gesture input lattices (G∘(G:W∘W)). FIG. 8 shows the result of this operation factored onto a single tape 800 and composed with T:(G×W)→M, resulting in a transducer G:W:M. Essentially the system simulates the three tape transducer by increasing the alphabet size by adding composite multimodal symbols that include both gesture and speech information. The system derives a lattice of possible meanings by projecting on the output of G:W:M.

Like other grammar-based approaches, multimodal language processing based on declarative grammars can be brittle with respect to unexpected or errorful inputs. On the speech side, one way to at least partially remedy the brittleness of using a grammar as a language model for recognition is to build statistical language models (SLMs) that capture the distribution of the user's interactions in an application domain. However, to be effective SLMs typically require training on large amounts of spoken interactions collected in that specific domain, a tedious task in itself. This task is difficult in speech-only systems and an all but insurmountable task in multimodal systems. The principles disclosed herein make multimodal systems more robust to disfluent or unexpected inputs in applications for which little or no training data is available.

A second source of brittleness in a grammar-based multimodal/unimodal interactive system is the assignment of meaning to the multimodal output. In a grammar based multimodal system, the grammar serves as the speech-gesture alignment model and assigns a meaning representation to the multimodal input. Failure to parse a multimodal input implies that the speech and gesture inputs could not be fused together and consequently could not be assigned a meaning representation. This can result from unexpected or errorful strings in either the speech or gesture of input or unexpected alignments of speech and gesture. In order to improve robustness in multimodal understanding, the system can employ more flexible mechanisms in the integration and the meaning assignment phases. Robustness in such cases is achieved by either (a) modifying the parser to accommodate for unparsable substrings in the input or (b) modifying the meaning representation so as to be learned as a classification task using robust machine learning techniques as is done in large scale human-machine dialog systems. A gesture edit machine can perform one or more of the following operations on gesture inputs: deletion, substitution, insertion, and aggregation. In one aspect of aggregation, the gesture edit machine aggregates one or more inputs of identical type as a single conceptual input. One example of this is when a user draws a series of separate lines which, if combined, would be a complete (or substantially complete) circle. The edit machine can aggregate the series of lines to form a single circle. In another example, a user hastily draws a circle on a touch screen to select a group of ice cream parlors, and then realizes that in her haste, the circle did not include a desired ice cream parlor. The user quickly draws a line which, if attached to the original circle, would enclose an additional area indicating the last ice cream parlor. The system can aggregate the two gestures to form a single conceptual gesture indicating all of the user's desired ice cream parlors. The system can also infer that the unincluded ice cream parlor should have been included. A gesture edit machine can be modeled by a finite-state transducer. Such a finite-state edit transducer can determine various semantically equivalent interpretations of given gesture(s) in order to arrive at a multimodal meaning.

One technique overcomes unexpected inputs or errors in the speech input stream with the finite state multimodal language processing framework and does not require training data. If the ASR output cannot be assigned a meaning then the system transforms it into the closest sentence that can be assigned a meaning by the grammar. The transformation is achieved using edit operations such as substitution, deletion and insertion of words. The possible edits on the ASR output are encoded as an edit finite-state transducer (FST) with substitution, insertion, deletion and identity arcs and incorporated into the sequence of finite-state operations. These operations can be either word-based or phone-based and are associated with a cost. Edits such as substitution, insertion, deletion, and others can be associated with a cost. Costs can be established manually or via machine learning. The machine learning can be based on a multimodal corpus based on the frequency of each edit and further based on the complexities of the gesture. The edit transducer coerces the set of strings (S) encoded in the lattice resulting from the ASR (λₛ) to closest strings in the grammar that can be assigned an interpretation. The string with the least cost sequence of edits (argmin) can be assigned an interpretation by the grammar. This can be achieved by composition (∘) of transducers followed by a search for the least cost path through a weighted transducer as shown below:

$${s}^{*} = {argmin}_{s ∈ S} {λ}_{s} \cdot {λ}_{edit} \cdot {λ}_{g}$$

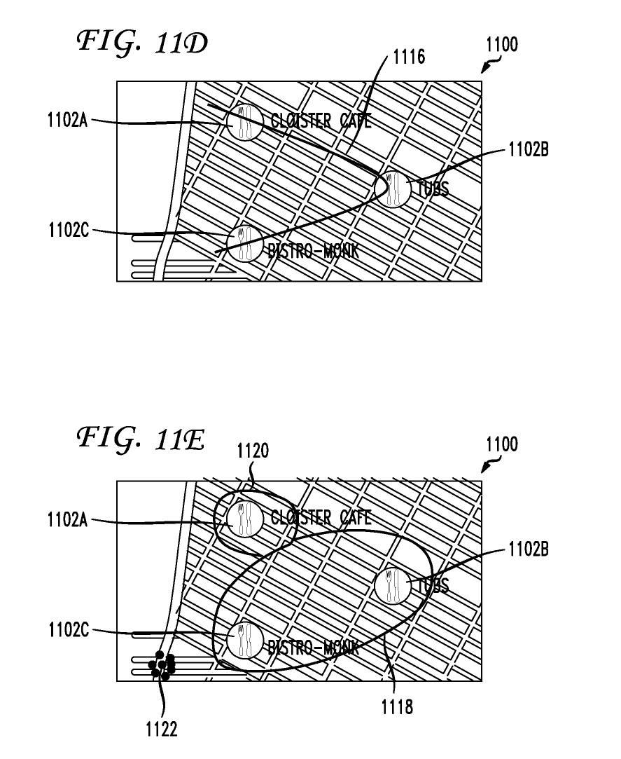

As an example in this domain the ASR output “find me cheap restaurants, Thai restaurants in the Upper East Side” might be mapped to “find me cheap Thai restaurants in the Upper East Side”. FIG. 9 shows an edit machine 900 which can essentially be a finite-state implementation of the algorithm to compute the Levenshtein distance. It allows for unlimited insertion, deletion, and substitution of any word for another. The costs of insertion, deletion, and substitution are set as equal, except for members of classes such as price (expensive), cuisine (Greek) etc., which are assigned a higher cost for deletion and substitution.

Some variants of the basic edit FST are computationally more attractive for use on ASR lattices. One such variant limits the number of edits allowed on an ASR output to a predefined number based on the application domain. A second variant uses the application domain database to tune the costs of edits of dispensable words that have a lower deletion cost than special words (slot fillers such as Chinese, cheap, downtown), and auto-complete names of domain entities without additional costs (e.g. “Met” for Metropolitan Museum of Art).

In general, recognition for pen gestures has a lower error rate than speech recognition given smaller vocabulary size and less sensitivity to extraneous noise. Even so, gesture misrecognitions and incompleteness of the multimodal grammar in specifying speech and gesture alignments contribute to the number of utterances not being assigned a meaning. Some techniques for overcoming unexpected or errorful gesture input streams are discussed below.

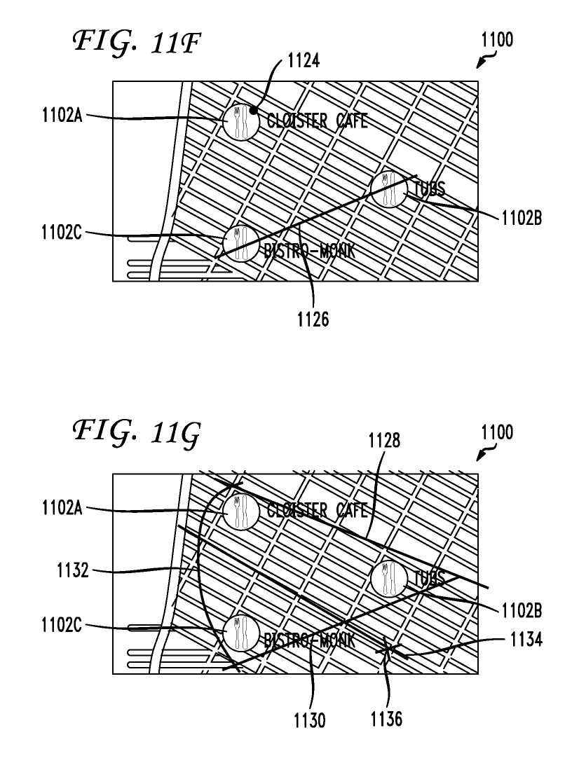

The edit-based technique used on speech utterances can be effective in improving the robustness of multimodal understanding. However, unlike a speech utterance, which is represented simply as a sequence of words, gesture strings are represented using a structured representation which captures various different properties of the gesture. One exemplary basic form of this representation is “G FORM MEANING (NUMBER TYPE) SEM”, indicating the physical form of the gesture, and having values such as area, point, line, and arrow. MEANING provides a rough characterization of the specific meaning of that form. For example, an area can be either a loc (location) or a sel (selection), indicating the difference between gestures which delimit a spatial location on the screen and gestures which select specific displayed icons. NUMBER and TYPE are only found with a selection. They indicate the number of entities selected (1, 2, 3, many) and the specific type of entity (e.g. rest (restaurant) or thtr (theater)). Editing a gesture representation allows for replacements within one or more value set. One simple approach allows for substitution and deletion of values for each attribute in addition to the deletion of any gesture. In some embodiments, gestures insertions lead to difficulties interpreting the inserted gesture. For example, when increasing a selection of two items to include a third selected item it is not clear a priori which entity to add as the third item. As in the case of speech, the edit operations for gesture editing can be encoded as a finite-state transducer, as shown in FIG. 10. FIG. 10 illustrates the gesture edit transducer 1000 with a deletion cost “delc” 1002 and a substitution cost “substc” 1004, 1008. FIGS. 3A-3D illustrate the role of gesture editing in overcoming errors. In this case, the user gesture is a drawn area but it has been misrecognized as a line. Also, a spurious pen tap or skip after the area has been recognized as a point. The speech in this case is “Chinese restaurants here” which requires an area gesture to indicate a location of the word “here” from the speech. The gesture edit transducer allows for substitution offline with area and for deletion of the spurious point gesture.

The system can encode each gesture in a stream of symbols. The path through the finite state transducer shown in FIG. 10 includes G 1002, area 1004, location 1006, and coords (representing coordinates) 1008, etc. This figure represents how a gesture can be encoded in a sequence of symbols. Once the gesture is encoded as a sequence of symbols, the system can manipulate the sequence of symbols. In one aspect, the system manipulates the stream by changing an area into a line or changing an area into a point. These manipulations are examples of a substitution action. Each substitution can be assigned a substitution cost or weight. The weight can provide an indication of how likely a line is to be misinterpreted as a circle, for example. The specific cost values or weights can be trained based on training data showing how likely one of gesture is to be misinterpreted. The training data can be based on multiple users. The training data can be provided entirely in advance. The system can couple training data with user feedback in order to grow and evolve with a particular user or group of users. In this manner, the system can tune itself to recognize the gesture style and idiosyncrasies of that user.

One kind of gesture editing that supports insertion is gesture aggregation. Gesture aggregation allows for insertion of paths in the gesture lattice which correspond to combinations of adjacent gestures. These insertions are possible because they have a well-defined meaning based on the combination of values for the gestures being aggregated. These gesture insertions allow for alignment and integration of deictic expressions (such as this, that, and those) with sequences of gestures which are not specified in the multimodal grammar. This approach overcomes problems regarding multimodal understanding and integration of deictic numeral expressions such as “these three restaurants”. However, for a particular spoken phrase a multitude of different lexical choices of gesture and combinations of gestures can be used to select the specified plurality of entities (e.g., three). All of these can be integrated and/or synchronized with a spoken phrase. For example, as illustrated in FIG. 11A, the user might circle on a display 1100 all three restaurants 1102A, 1102B, 1102C with a single pen stroke 1104. As illustrated in FIG. 11B, the user might circle each restaurant 1102A, 1102B, 1102C in turn 1106, 1108, 1110. As illustrated in FIG. 11C, the user might circle a group of two 1114 and a group of one 1112. When one gesture does not completely enclose an item (such as the logo and/or text label) as shown by gesture 1114, the system can edit the gesture to include the partially enclosed item. The system can edit other errorful gestures based on user intent, gesture history, other types of input, and/or other relevant information.

FIGS. 11D-11G provide additional examples of gesture inputs selecting restaurants 1102A, 1102B, 1102C on the display 1100. FIG. 11D depicts a line gesture 1116 connecting the desired restaurants. The system can interpret such a line gesture 1116 as errorful input and convert the line gesture to the equivalent of the large circle 1104 in FIG. 11A. FIG. 11E depicts one potential unexpected gesture and other errorful gestures. In this case, the user draws a circle gesture 1118 which excludes a desired restaurant. The user quickly draws a line 1120 which is not a closed circle by itself but would enclose an area if combined with the circle gesture 1118. The system ignores a series of taps 1122 which appear to be unrelated to the other gestures. The user may have a nervous habit of tapping the screen 1100 while making a decision, for instance. The system can consider these taps meaningless noise and discard them. Likewise, the system can disregard or discard doodle-like or nonsensical gestures. However, tap gestures are not always discarded; tap gestures can be meaningful. For example, in FIG. 11F, the gesture editor can aggregate a tap gesture 1124 with a line gesture 1126 to understand the user's intent. Further, in some situations, a user can cancel a previous gesture with an X or a scribble. FIG. 11G shows three separate lines 1128, 1130, 1132 bounding in a selection area. The gesture 1134 was erroneously drawn in the wrong place, so the user draws an X gesture 1136, for example, on the erroneous line to cancel it. The system can leave that line on the display or remove it from view when the user cancels it. In another embodiment, the user can rearrange, extend, split, and otherwise edit existing on-screen gestures through multimodal input such as additional pen gestures. The situations shown in FIG. 11A-FIG. 11G are examples. Other gesture combinations and variations are also anticipated. These gestures can be interspersed by other multimodal inputs such as key presses or speech input.

In any of these examples, consider a user who makes nonsensical gestures, such as doodling on the screen or nervously tapping the screen while making a decision. The system can edit out these gestures as noise which should be ignored. After removing nonsensical or errorful gestures, the system can interpret the rest of gestures and/or input.

In one example implementation, gesture aggregation serves as a bottom-up pre-processing phase on the gesture input lattice. A gesture aggregation algorithm traverses the gesture input lattice and adds new sequences of arcs which represent combinations of adjacent gestures of identical type. The operation of the gesture aggregation algorithm is described in pseudo-code in Algorithm 1. The function plurality( ) retrieves the number of entities in a selection gesture, for example, for a selection of two entities, g1, plurality(g1)=2. The function type( ) yields the type of the gesture, for example rest for a restaurant selection gesture. The function specific_content ( ) yields the specific IDs.

Algorithm 1 - Gesture aggregation

| P = the list of all paths through the gesture lattice GL | |
|---|---|
| while P != 0 do | |
| p = pop(P) | |
| G = the list of gestures in path p | |
| i = 1 | |
| while i < length (G) do | |
| if g[i] and g[i + 1] are both selection gestures then | |
| if type (g[i]) == type(g[i + 1]) then | |
| plurality = plurality(g[i]) + plurality(g[i + 1]) | |
| start = start_state(g[i]) | |
| end = end_state(g[i + 1]) | |
| type = type(g[i]) | |
| specific = append( | specific_content(g[i]), |
| | specific_content(g[i + 1]) |

```
        g′ = G area sel plurality type specific
        Add g′ to GL starting at state start and ending at state end
        p′ = path p but with arcs from start to end replaced with g′
        push p′ onto P
        i++
      end if
    end if
  end while
end while
```

This algorithm performs closure on the gesture lattice of a function which combines adjacent gestures of identical type. For each pair of adjacent gestures in the lattice which are of identical type, the algorithm adds a new gesture to lattice. This new gesture starts at the start state of the first gesture and ends at the end state of the second gesture. Its plurality is equal to the sum of the pluralities of the combining gestures. The specific content for the new gesture (lists of identifiers of selected objects) results from appending the specific contents of the two combining gestures. This operation feeds itself so that sequences of more than two gestures of identical type can be combined.

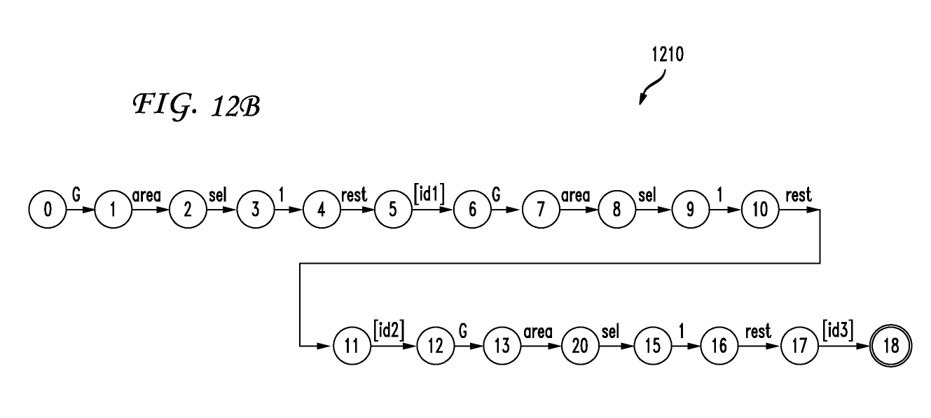

For the example of three selection gestures on individual restaurants as in FIG. 11B, the gesture lattice before aggregation 1206 is shown in FIG. 12B. After aggregation, the gesture lattice 1200 is as in FIG. 12A. The aggregation process added three new sequences of arcs 1202, 1204, 1206. The first arc 1202 from state 3 to state 8 results from the combination of the first two gestures. The second arc 1204 from state 14 to state 24 results from the combination of the last two gestures, and the third arc 1206 from state 3 to state 24 results from the combination of all three gestures. The resulting lattice after the gesture aggregation algorithm has applied is shown in FIG. 12A. Note that minimization may be applied to collapse identical paths 1208, as is the case in FIG. 12A.

A spoken expression such as “these three restaurants” aligns with the gesture symbol sequence “G area sel 3 rest SEM” in the multimodal grammar. This will be able to combine not just with a single gesture containing three restaurants but also with the example gesture lattice, since aggregation adds the path: “G area sel 3 rest [id1, id2, id3]”.

This kind of aggregation can be called type-specific aggregation. The aggregation process can be extended to support type non-specific aggregation in cases where a user refers to sets of objects of mixed types and selects them using multiple gestures. For example, in the case where the user says “tell me about these two” and circles a restaurant and then a theater, non-type specific aggregation can combine the two gestures into an aggregate of mixed type “G area sel 2 mix [(id1, id2)]” and this is able to combine with these two. For applications with a richer ontology with multiple levels of hierarchy, the type non-specific aggregation should assign to the aggregate to the lowest common subtype of the set of entities being aggregated. In order to differentiate the original sequence of gestures that the user made from the aggregate, paths added through aggregation can, for example, be assigned additional cost.

Multimodal interfaces can increase the usability and utility of mobile information services, as shown by the example application to local search. These goals can be achieved by employing robust approaches to multimodal integration and understanding that can be authored without access to large amounts of training data before deployment. Techniques initially developed for improving the ability to overcome errors and unexpected strings in the speech input can also be applied to gesture processing. This approach can allow for significant overall improvement in the robustness and effectiveness of finite-state mechanisms for multimodal understanding and integration.

In one example, a user gestures by pointing her smartphone in a particular direction and says “Where can I get Pizza in this direction?” However, the user is disoriented and points her phone south when she really intended to point north. The system can detect such erroneous input and prompt the user through an on-screen arrow and speech which pizza places are available where the user intended to point, but did not point. The disclosure covers errorful gestures of all kinds in this and other embodiments.

Embodiments within the scope of the present invention may also include tangible and/or intangible computer-readable media for carrying or having computer-executable instructions or data structures stored thereon. Such computer-readable media can be any available media that can be accessed by a general purpose or special purpose computer, including the functional design of any special purpose processor as discussed above. By way of example, and not limitation, such tangible computer-readable media can comprise RAM, ROM, EEPROM, CD-ROM or other optical disk storage, magnetic disk storage or other magnetic storage devices, or any other medium which can be used to carry or store desired program code means in the form of computer-executable instructions, data structures, or processor chip design. When information is transferred or provided over a network or another communications connection (either hardwired, wireless, or combination thereof) to a computer, the computer properly views the connection as a computer-readable medium. Thus, any such connection is properly termed a computer-readable medium. Tangible computer-readable media expressly exclude wireless signals, energy, and signals per se. Combinations of the above should also be included within the scope of the computer-readable media.

Computer-executable instructions include, for example, instructions and data which cause a general purpose computer, special purpose computer, or special purpose processing device to perform a certain function or group of functions. Computer-executable instructions also include program modules that are executed by computers in stand-alone or network environments. Generally, program modules include routines, programs, objects, data structures, components, and the functions inherent in the design of special-purpose processors, etc. that perform particular tasks or implement particular abstract data types. Computer-executable instructions, associated data structures, and program modules represent examples of the program code means for executing steps of the methods disclosed herein. The particular sequence of executable instructions or associated data structures represents examples of corresponding acts for implementing the functions described in such steps.

Those of skill in the art will appreciate that other embodiments of the invention may be practiced in network computing environments with many types of computer system configurations, including personal computers, hand-held devices, multi-processor systems, microprocessor-based or programmable consumer electronics, network PCs, minicomputers, mainframe computers, and the like. Embodiments may also be practiced in distributed computing environments where tasks are performed by local and remote processing devices that are linked (either by hardwired links, wireless links, or by a combination thereof) through a communications network. In a distributed computing environment, program modules may be located in both local and remote memory storage devices.

The various embodiments described above are provided by way of illustration only and should not be construed to limit the invention. For example, the principles herein may be applicable to mobile devices, such as smart phones or GPS devices, interactive web pages on any web-enabled device, and stationary computers, such as personal desktops or computing devices as part of a kiosk. Those skilled in the art will readily recognize various modifications and changes that may be made to the present invention without following the example embodiments and applications illustrated and described herein, and without departing from the true spirit and scope of the present invention.

We claim:

1. A computer-implemented method of multimodal interaction, the method comprising:
receiving a plurality of multimodal inputs associated with a query, the plurality of multimodal inputs including at least one gesture input;
editing the at least one gesture input with a gesture edit machine; and
responding to the query based on the edited at least one gesture input and the remaining multimodal inputs.

2. The computer-implemented method of claim 1, wherein the at least one gesture input comprises at least one unexpected gesture.

3. The computer-implemented method of claim 1, wherein the at least one gesture input comprises at least one errorful gesture.

4. The computer-implemented method of claim 1, wherein the gesture edit machine performs one or more action selected from a list comprising deletion, substitution, insertion, and aggregation.

5. The computer-implemented method of claim 1, wherein the gesture edit machine is modeled by a finite-state transducer.

6. The computer-implemented method of claim 1, the method further comprising:
generating a lattice for each multimodal input;
generating an integrated lattice which represents a combined meaning of the generated lattices by combining the generated lattices; and
responding to the query further based on the integrated lattice.

7. The computer-implemented method of claim 6, the method further comprising capturing the alignment of the lattices in a single declarative multimodal grammar representation.

8. The computer-implemented method of claim 7, wherein a cascade of finite state operations aligns and integrates content in the lattices.

9. The computer-implemented method of claim 7, the method further comprising compiling the multimodal grammar representation into a finite-state machine operating over each of the plurality of multimodal inputs and over the combined meaning.

10. The computer-implemented method of claim 4, wherein the action of aggregation aggregates one or more inputs of identical type as a single conceptual input.

11. The computer-implemented method of claim 1, wherein the plurality of multimodal inputs are received as part of a single turn of interaction.

12. The computer-implemented method of claim 1, wherein gesture inputs comprise one or more of stylus-based input, finger-based touch input, mouse input, and other pointing device input.

13. The computer-implemented method of claim 1, wherein responding to the request comprises outputting a multimodal presentation that synchronizes one or more of graphical callouts, still images, animation, sound effects, and synthetic speech.

14. The computer-implemented method of claim 1, wherein editing the at least one gesture input with a gesture edit machine is associated with a cost established either manually or via learning based on a multimodal corpus based on the frequency of each edit and further based on gesture complexity.

15. A system for multimodal interaction, the system comprising:
a processor;
a module configured to control the processor to receive a plurality of multimodal inputs associated with a query, the plurality of multimodal inputs including at least one gesture input;
a module configured to control the processor to edit the at least one gesture input with a gesture edit machine; and
a module configured to control the processor to respond to the query based on the edited at least one gesture input and the remaining multimodal inputs.

16. The system of claim 15, wherein the at least one gesture input comprises at least one unexpected gesture.

17. The system of claim 15, wherein the at least one gesture input comprises at least one errorful gesture.

18. The system of claim 15, wherein the gesture edit machine performs one or more action selected from a list comprising deletion, substitution, insertion, and aggregation.

19. A tangible computer-readable medium storing a computer program having instructions for multimodal interaction, the instructions comprising:
receiving a plurality of multimodal inputs associated with a query, the plurality of multimodal inputs including at least one gesture input;
editing the at least one gesture input with a gesture edit machine; and
responding to the query based on the edited at least one gesture input and the remaining multimodal inputs.

20. The tangible computer-readable medium of claim 18, wherein the gesture edit machine performs one or more action selected from a list comprising deletion, substitution, insertion, and aggregation.
